(19) United States
(12) Patent Application Publication
(10) Pub. No.: US 2018/0279637 A1
(43) Pub. Date: Oct. 4, 2018

(54) SYSTEM AND METHOD FOR DETERMINING CONDITIONS OF STORE PRODUCE DISPLAY

(71) Applicant: Walmart Apollo, LLC, Bentonville, AR (US)

(72) Inventors: Yurgis Mauro Bacallao, Centerton, AR (US); Douglas Jahe Ryner, Cave Springs, AR (US)

(21) Appl. No.: 15/941,250

(22) Filed: Mar. 30, 2018

Related U.S. Application Data
(60) Provisional application No. 62/481,438, filed on Apr. 4, 2017.

(51) Int. Cl. A23B 7/148; B65D 88/74

(52) U.S. Cl. CPC A23B 7/148; A23V 2002/00; B65D 88/74

(57) ABSTRACT

An air circulation and ventilation system for a retail store produce display comprises an air flow system that outputs an air flow to the produce display; a sensor system that determines a condition of the produce in the produce display; a sensor controller that controls the air flow system to change the air flow in the produce display in response to the condition of the produce in the produce display; and a self-contained power panel for powering the air flow system and the sensor system.

### RELATED APPLICATIONS

This application claims priority to U.S. Provisional Patent Application Ser. No. 62/481,438, filed on Apr. 4, 2017 and entitled “System and Method for Determining Conditions of Store Produce Display,” the entirety of which is incorporated by reference herein.

### TECHNICAL FIELD

The present inventive concepts relate generally to store produce displays, and more specifically, to sensing conditions of a produce display bed.

### BACKGROUND

Retail establishments face the ongoing challenge of storing and displaying fruits, vegetables, and/or other perishables and preserving their freshness as long as possible.

One approach is to provide a refrigerated environment where fresh cold air is pumped into the display. However, this requires an expensive infrastructure and limits mobility and flexibility of the display table.

### SUMMARY

In one aspect, provided is an air circulation and ventilation system for a retail store produce display, comprising: an air flow system that outputs an air flow to the produce display; a sensor system that determines a condition of the produce in the produce display; a sensor controller that controls the air flow system to change the air flow in the produce display in response to the condition of the produce in the produce display; and a self-contained power panel for powering the air flow system and the sensor system.

In some embodiments, the sensor system includes a plurality of gas sensors that sense an emission of a gas from the produce in the produce display, and determines an amount of freshness or ripeness of the produce based on the emitted gas.

In some embodiments, the sensor controller reverses the air flow in the produce display in response to the gas sensors determining that the emitted gas exceeds a threshold.

In some embodiments, the sensor controller outputs an instruction to the air flow system to reverse the air flow at an automated, regular time interval.

In some embodiments, the sensor system further comprises a plurality of weight sensors that determine a presence or change in weight of the produce, and the sensor controller changes the air flow in the produce display in response to the sensor system determining that the produce display is devoid of the produce or that the produce has changed weight.

In some embodiments, the weight sensors include a scale that communicates with the sensor system to determine if vents in the air flow system need to be operating.

In some embodiments, the scale communicates with the sensor system to change fan speeds of the air flow system and modify air circulation.

In some embodiments, the system further comprises a notification system comprising: a sensor transmitter that outputs data in a non-visual light spectrum; at least one optical sensor that detects the non-visual light spectrum; and a controller that outputs notification data received in the non-visual light spectrum, the notification data including information for a user of the condition of the produce in the produce display.

In another aspect, provided is a display table or kiosk for store produce items, comprising: a base; a produce bed on the base for holding retail produce items; an air circulation and ventilation system that outputs a controlled air flow to the produce bed, monitors a condition of the produce in the produce display, and changes the air flow in the produce display in response to the condition of the produce in the produce display; and a notification system that outputs information of the condition of the produce in the produce display.

In some embodiments, the display table or kiosk further comprises a bottom section including shelves.

In some embodiments, the display table or kiosk further comprises a perimeter and divider forming sectional divisions about the produce bed.

In some embodiments, the display table or kiosk further comprises a self-contained power panel for powering the air circulation and ventilation system and the notification system.

In some embodiments, the power panel is a solar panel or incandescent power panel.

In some embodiments, the air circulation and ventilation system comprises: an air flow system that outputs the air flow to the produce display; a sensor system that determines the condition of the produce in the produce display; and a sensor controller that controls the air flow system to change the air flow in the produce display in response to the condition of the produce in the produce display.

In some embodiments, the air flow system includes a plurality of fans powered by the power panel for providing air induction.

In some embodiments, the sensor system further comprises a plurality of weight sensors that determine a presence or change in weight of the produce, and wherein the sensor controller changes the air flow in the produce display in response to the sensor system determining that the produce display is devoid of the produce or that the produce has changed weight.

In some embodiments, the display table or kiosk further comprises a notification system comprising: a sensor transmitter that outputs data in a non-visual light spectrum; at least one optical sensor that detects the non-visual light spectrum; and a controller that outputs notification data received in the non-visual light spectrum, the notification data including information for a user of the condition of the produce in the produce display.

In another aspect, provided is a sensor system that determines a condition of the produce in the produce display, comprising: a plurality of gas sensors that sense an emission of a gas from the produce in the produce display, and determines an amount of freshness or ripeness of the produce based on the emitted gas; a plurality of weight sensors that determine a presence or change in weight of the produce, at least one optical sensor that detects wavelengths of light including notification data from a sensor transmitter, the notification data including information regarding the condition of the produce in response to the gas and weight sensors; and a sensor controller that controls a source of air flow in the product display in response to a detected condition of the produce detected by gas and weight sensors.

### BRIEF DESCRIPTION OF THE DRAWINGS

Advantages of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 is a perspective view of a produce display table, in accordance with some embodiments.

FIG. 2 is a perspective view of an air flow sensor system for the produce display table of FIG. 1, in accordance with some embodiments.

FIG. 3 is a perspective view of air flow and gas sensor systems for the produce display table of FIG. 1 or 2, in accordance with some embodiments.

FIG. 4 is a schematic view of the air flow and sensor systems of FIGS. 1-3 illustrating air flow paths between elements of the systems, in accordance with some embodiments.

FIG. 5 is a perspective view of air flow and pressure sensor systems for the produce display table of FIG. 1, in accordance with some embodiments.

### DETAILED DESCRIPTION OF EMBODIMENTS

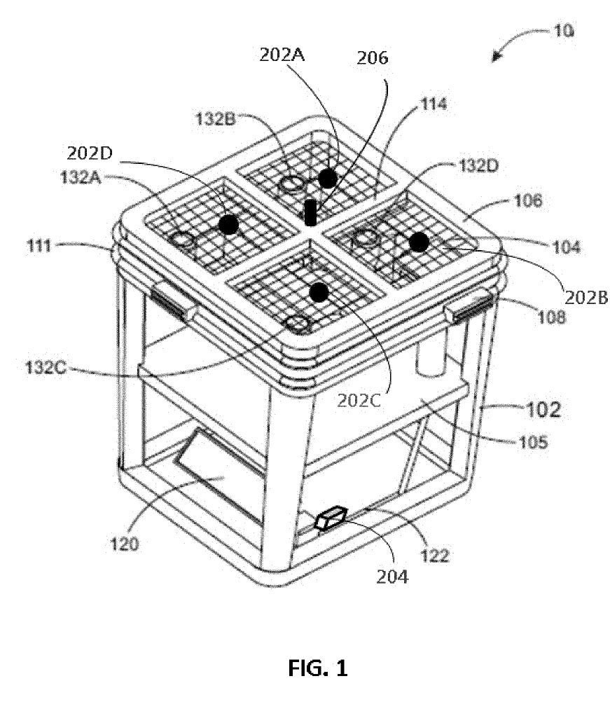

FIG. 1 is a perspective view of a produce display table 10, in accordance with some embodiments. The produce display table 10 is constructed and arranged to aid in the ripening of perishable store items, such as produce, and/or maintaining freshness of the produce, by controlling air flow in a manner that keeps fruits, vegetables, and other perishable items fresh longer that a conventional store display. Related features may include providing ventilation for purging gases from the produce bed, preserving ripeness, freshness, or other desired benefits, and providing constant air circulation. In other embodiments, a storage apparatus different than a table may equally apply, such as a kiosk, counter, station, and so on.

In some embodiments, the display table 10 includes a base 102, a produce bed 104, a bottom section 105, an air flow system 130, a gas sensor system 140, and a self-contained power panel 120 for powering the air flow system 130 without the need for external outlet connections. In some embodiments, display table 10 may have a retractable wheel assembly (not shown). The display table 10 includes a compact design and configuration, which permits the presence of the bottom section 105, which may include shelves, additional bag holders, while also providing air circulation and/or ventilation by way of the self-contained power panel 120.

The base 102 and/or produce bed 104 can have a shape of a square, rectangular, oval, circle, polygon, trapezoid, or other shape, or a combination thereof. For example, the produce bed 104 and/or frame or border 106 about a perimeter of the produce bed 104, may have a rectangular shape with rounded corners. In some embodiments, the display table 10 has a unitary (not modular) construction. A cart bumping feature 111 may extend about some or all of an outer surface of the table border 106, for example, formed of foam, plastic, or the like for absorbing a force applied by a shopping cart or other object. The border 106 about the perimeter of the produce bed 104 is constructed for containing items at the produce bed 104, and therefore preventing items from falling off the produce bed 104. In some embodiments, the produce bed 104 may separated into multiple regions by one or more dividers 114, but not limited thereto.

The sides of the base 102 and/or bottom section 105 may be open, i.e., no structural walls, so that the air flow system 130 can receive sufficient ventilation for receiving and distributing a flow of air to the produce bed 104. The shelves in the bottom section 105 may similarly include vents, holes, or the like for receiving a flow of air. In some embodiments, the air flow system 130 may extend to the bottom section 105, for providing an air flow to items positioned at the bottom section 105.

The base 102 may include bag holder supports 108, for example, positioned at one or more corners of the display table 10 so that store customers can remove items from the display table 10 and place them in bags hanging from the holders supports 108. The bag holder supports 108 may be constructed and arranged as hooks, clamps, permanent or removable fixtures, or related support structures.

The produce bed 104 may be formed of a mesh, screen, or other porous configuration to provide sufficient ventilation and so that air may circulate from a region below the produce bed 104, for example, generated by the air flow system 130 below the table portion, to perishable items positioned on the produce bed 104.

The air flow system 130 circulates fresh air throughout the table display 10, and provides ventilation for the produce items positioned on the produce bed 104 and/or bottom section 105.

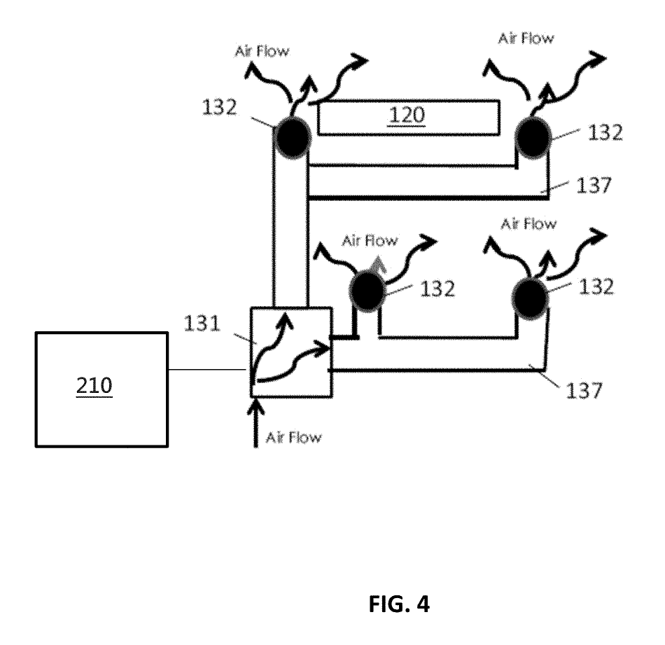

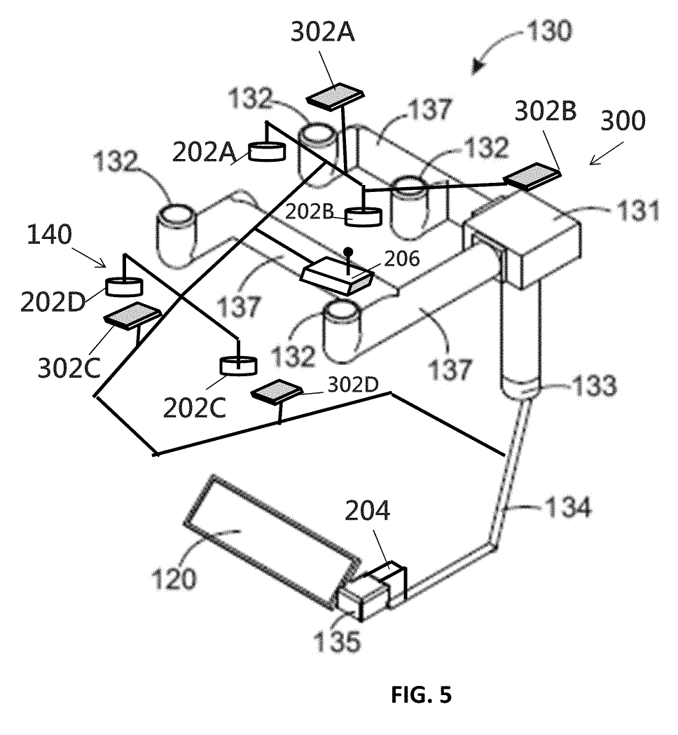

As shown in FIGS. 4 and 5, in some embodiments, the air flow system 130 includes but is not limited to an air distribution unit 131, a plurality of fans 132A-D (generally, 132) in communication with the air distribution unit 131 via air ducts 137 or related pipes or air flow distribution elements, and a main electric fan with filter 133. In some embodiments, the air flow system 130 includes a single main fan 133, two distribution unit fans 138, and six side fans 132, all powered by photovoltaic cells of the power panel 120. The fans may be induction fans, for example, allowing an induction of air into the flow pattern produced for providing fresh air, ventilation, and so on in in the produce bed 104. In some embodiments, the fans 132 and sensors 202 may also, or in addition, be positioned at the bottom section 105, for example, shelves where produce items may be positioned.

The fans 132, 133, 138 are powered by a converter 135 that outputs AC or DC power via electrical wiring 134 of the like to the fans 132, 133, 138. The fans 132, 133, 138 are preferably low power fans. Here, each fan 132, 133, 138 may require up to 5 volts and/or 2 amperes of electricity from the converter 135 and/or battery (not shown) in communication with the power panel 120 and/or converter 135.

The side fans 132 may be supply and/or return fans, for example, constructed and arranged to output a source of air to a predetermined region of the produce bed 104 and/or bottom section 105. In some embodiments, each divided region of the display table 10 includes a dedicated fan 132. In some embodiments, the side fans 132 may be the same. In other embodiments, the side fans 132 may be different. For example, the side fans 132A-132D of FIGS. 1 and 4 may have a different size or power requirement to circulate air in a different manner in each region of the produce bed 104.

The main fan 133, or intake fan, includes a filter for filtering air drawn in from the ambient environment at which the display table 10 is located, which is directed to the air distribution unit 131. The air distribution unit 131 moves the air to the air ducts 137 for distribution to the various regions of the display table 10, and in turn for output via air ducts 137 to the side fans 132.

The distribution unit fans 138 are each positioned at an interface between the air distribution unit 131 and an air duct 137 to output filtered air at a constant or controlled volume, and to distribute the air via the ducts 137 equally, or at rates controlled by a sensor controller 210 of the air distribution box 131 (described below).

The air flow system 130 is self-powered by the power panel 120. In some embodiments, the power panel 120 is positioned at the foot of the base 102, for example, as shown. The power panel 120 receives energy from a light source such as the sun, ceiling lights, or the like. The location of the power panel 120 is not limited to the base 102. For example, the power panel 120 may be positioned along the table border 102, the dividers 114, and/or the produce bed 104, and other region(s) of the produce display table 10 that can receive solar radiation, incandescent light, or other source of energy. For example, some or all of the produce bed 104 may be configured to include solar panels or the like positioned along a top surface of the produce bed 104. In some embodiments, the produce bed 104 includes a material, or is coated with a material, that collects and converts a source or solar or incandescent energy into electricity.

The power panel 120 may include a plurality of photovoltaic cells, i.e., solar cells or the like for collecting and processing solar radiation, incandescent light, or other source of energy to convert it into electricity for powering the fans 132 of the air flow system 130. In some embodiments, the power panel 130 may include solar panels or the like that power a DC fan motor of the fans 132. The power panel 120 may include at least one battery for storing the collected and converted source of energy for subsequent output to the air flow system 130. The battery can be charged by the self-contained power panel 120 for providing the power to the fans 131, 132, 138, the sensors 202, 302, and or other electrical components of the produce display table 10. In some embodiments, other electrical elements may receive the converted electricity from the power panel 120, for example, light bulbs.

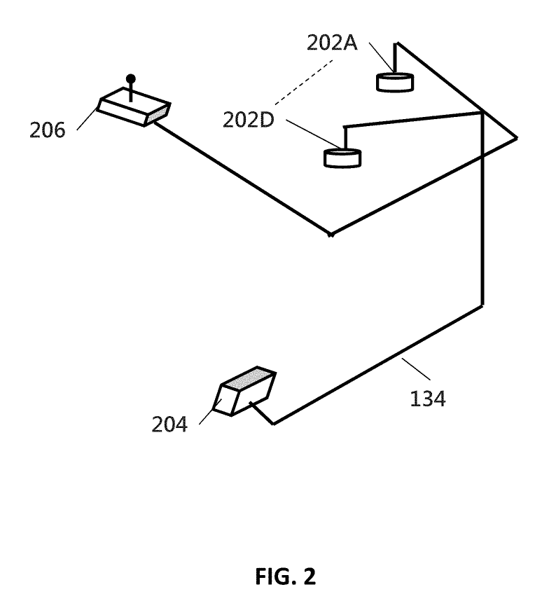

Referring to FIGS. 2-5, the gas sensor system 140 may aid the air flow system 130 in controlling conditions in the produce bed 104 with respect to determining whether the produce bed 104 has ripe produce and/or how ripe the produce is in the bed 104. In some embodiments, the gas sensor system 140, like the air flow system 130, is self-powered by the power panel 120. The same power panel 120 may power both the gas sensor system 140 and air flow system 130 so that external power sources are not required. In some embodiments, the gas sensor system 140 draw power from the air distribution unit 131 which in turn receives power from the power converter 135. Here, conductive wiring 134 or the like may provide electrical and/or communication paths between the sensors 202, a sensor transmitter 206, and/or air sensor electrical box 204 and the power source, i.e., converter 135 or air distribution unit 131.

As shown in FIG. 2 the gas sensor system 140 may include a plurality of sensors 202A, B (generally, 202) an air sensor electrical box 204, a sensor transmitter 206, and a sensor controller 210 of the air distribution unit 131. Some or all of the gas sensor system 140 may be located in the enclosure of the produce display table 10. For example, elements such as the sensor controller, instead of being part of the air distribution unit 131, may be remote from the produce display table 10 but in communication with the other elements via the sensor transmitter 206, for example, an LED sensor transmitter or wired or wireless communication network devices.

In some embodiments, the sensors 202 are air gas sensors or the like that can measure or otherwise gauge the freshness of one or more different produce items, such as fruits, vegetables, meats, and so on. For example, the sensors 202 may measure the ripeness of fruit positioned in the produce display 10. As fruit matures, it releases gases such as ethylene that causes the ripening process to begin. As the fruit matures, more ethylene is released. In this example, the sensors 202 may be inexpensive ethylene sensors, but not limited thereto.

In some examples, combinations of different sensors 202 may be positioned at various locations in the display table 10. Referring to FIG. 1, one display quadrant (separated by divider 114) may receive certain ethylene-emitting fruits and vegetables. This display quadrant may be configured with ethylene sensors 202A. Another display quadrant may be configured with a different sensor, for example, sensors 202B, for example, that detect ethyl mercaptan or related gas, chemical, or other indicator of spoiled meat, so that meat may be displayed at the other display quadrant. The sensors 202 may measure concentrations of such gases, particles, or the like in the air circulating at or about the display table 10, for example, the multiple regions separated by the dividers 114. In other examples, the sensors 202 may produce radio frequencies, microwaves, radiation, infrared light, and/or other electromagnetic radiation to determine the ripeness of various perishable items.

The sensors 202 may include or otherwise communicate with output devices, such as radio-frequency identification chips, transmitters, or optical sensors or the like, which in turn communicate with the sensor transmitter 206, which may output notification data, for example, indicating a status of the produce table 10 in view of gases or the like detected by gas sensors 202.

The electrical box 204 provides electricity for the electronic components of the display table 10. In some embodiments, the electrical box 204 can process electricity from two sources (dual-power) or more than two sources. For example, the electrical box 204 can process both electricity converted by the power panel 120 and electricity from conventional power sources such as an electrical outlet, battery, and so on. The electrical box 204 may output electricity solely from the power panel 120 when no power connections are available for electricity from conventional sources such as electrical outlets or the like. In some embodiments, the electrical box 204 includes a computer processor that communicates with a mechanical switch to automatically switch between alternative power provided by the solar panels or the like and a source of electricity provided by a wall outlet or the like, for example, according to a predetermined voltage level required to perform a function. For example, when the fans are required to operate at high speeds, the system may derive power from the wall outlet or the like, and at low speeds derive power from the self-contained power panel that provides alternative energy.

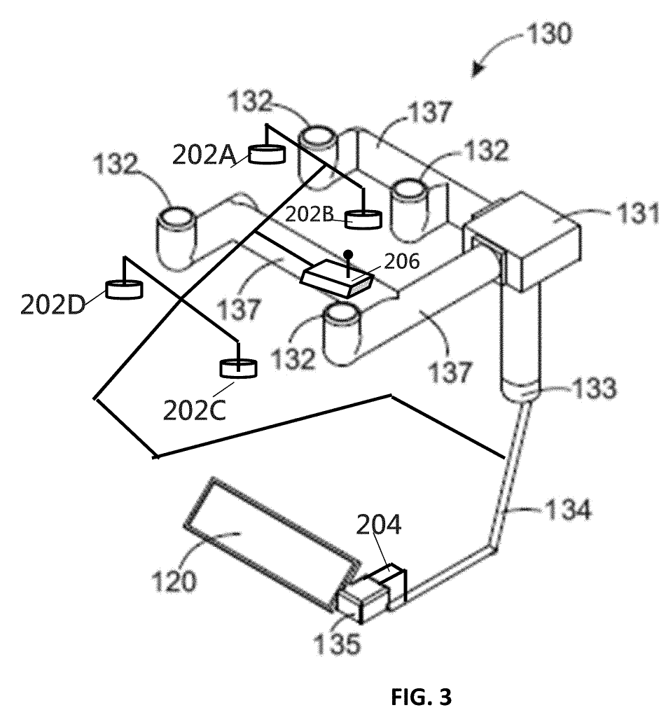

As describe above and further shown in FIGS. 3 and 4, the sensor system 140 is constructed and arranged to control the air flow of the air flow system 130 by determining if the produce bed 104 has ripe produce and how ripe the produce is. To achieve this, fresh air is circulated by the air flow system fans 132, 133, 138 through the ducts 137 to provide cleanliness, e.g., removing contaminants, and to allow the air to exit at the appropriate location to preserve produce or other perishable products requiring ventilation to preserve freshness. Flow paths may provide a source of fresh air received at the display table 10 via air system vents or the like, for example, a filtered region below the main fan 133. The source of fresh air may be vented by the side vents proximal side fans 132 and/or main fan filter to reduce or eliminate contamination. The main fan 133 directs the fresh air to the air distribution unit 131, which in turn distributes the air to the side fans 132 for constant circulation about the produce bed 104. In some embodiments, the fans 132 may also, or in addition, be positioned at the bottom section 105, for example, shelves where produce items may be positioned. The foregoing air flow paths may therefore equally apply to the bottom section 105.

The sensor controller 210 function of the air distribution unit 131 can control the air flow by controlling the manner in which the air distribution unit 131 moves the air to the air ducts 137 for distribution to the various regions of the display table 10. This may be achieved by adjusting the speed, power, or other features of one or more various fans 131, 132, 138 and/or vents, valves or the like in the air distribution unit 131 and/or other elements of the air flow system 130 according to the gas sensors 202, for example, when the gas sensors 202 detect a gas indicative of produce freshness, ripeness, or other characteristic. In some embodiments, one or more gas sensors 202 may be associated with a particular side fan 132 and/or other fan 131, 138. For example, as shown in FIG. 1, gas sensor 202A may be neighboring fan 132B at an opening in an air duct 137, which outputs fresh air to a region of the produce bed 104 and/or removes air from the produce bed 104 for ventilation purposes. In this example, a speed of the fan 132B, and only fan 132B, may be increased in response to gas sensor 202A sensing a predetermined amount of gas indicative of produce freshness. The controller 210 may receive a signal from the gas sensor 202A, and in turn automatically generate and output a command to the fan 132 to increase its speed, rotations per second, and so on. The other fans 132A, 132C, 132D may not change since their corresponding sensors 202 did not sense the gas and therefore did not trigger a command to change fan speeds.

In some embodiments, the controller 210 may reverse the air flow, for example, on a predetermined basis, for example, hourly, or in response to a detection by the sensors 202 of a particular condition of the produce, for example, ripe or overripe or under ripe condition determined from an amount of gas emitted by the produce and detected in the air flow by the sensors 202. In particular, the air flow system 130 is constructed and arranged to provide air to the produce bed 104 or to remove air from the produce bed. If ventilation is required, then the air flows through the vents. The gas sensors 202 and/or other sensors such as weight sensors or the light described herein are positioned at the produce bed 104 to measure conditions establishing which direction the air flow occurs. In this example, the air flow may be reversed to remove contaminants from the produce bed 104 that are detected by the sensors 202. In some embodiments, a region of the produce bed 104 may remove air to reduce cross contamination with produce items in other regions of the produce bed 104.

Thus, the controller 210 can control the air flow, the direction of the air flow, a time of air flow, and/or amount of air flow depending on information provided by the sensors 202, e.g., a threshold amount of sensed ethylene emitted from ripe fruit.

In addition to measuring produce display conditions, in some embodiments, the sensor system 140 provides for sustained communication with store associates or other users responsible for the management of the produce display table 10. The sensor transmitter 206 may be used to communicate with the air sensor electrical box 204 and/or sensor controller 210, which in turn can output data to a remote computer, such as a user's mobile device, e.g., a smartphone. For example, the air distribution box may include a wireless transmitter (not shown).

In some embodiments, the sensors 202, sensor transmitter 206, one or more optical sensors, and controller 210 collectively form a notification system. In some embodiments, the sensors 202 include both air gas sensors and optical sensors. In embodiments, multiple sensor transmitters 206 may be positioned at the display table 10, for example, one transmitter 206 at each of the four regions separated by divider 114 shown at FIG. 1. A sensor transmitter 206 is constructed and arranged on the produce display table 10 to generate non-visible light emitting status signals regarding detected gases indicating ripeness, spoilage, and so on of produce of the display table. The sensor transmitter 206 may modulate light used to convey data on carrier light waves, the data providing any of the various messages, status and/or data information regarding a status, condition, or indicator of the produce table 10. One or more optical sensors (not shown) may be positioned at the display table 10, for example, co-located in the air distribution unit 131, for detecting invisible or nonvisible light emitted from the sensor transmitter(s) 106. For example, the optical sensor may identify non-visible wavelengths emitted from a sensor transmitter 106 and identify the gas sensor(s) 202 associated with the sensor transmitter 106. A controller, which may be part of the sensor controller 210 or a different controller, communicates with the optical sensor, and is configured to provide a notification regarding the detection of the non-visible wavelength from the transmitter 206 and associated gas sensor(s) 202. The controller may include a transmitter, for example, WiFi transmitter, network interface, or the like, for outputting notification data to a remote electronic device, such as a store employee computer. The remote device may output commands via the network to the controller to control the speed of the fans, adjust sensor detection values, e.g., control a sensor to detect a particular number of parts per million (ppm) of a particular chemical, gas, and so on. In some embodiments, the air distribution box may include a wireless transmitter (not shown) for establishing such communications.

In FIGS. 1-4, gas sensors 202 are shown and described. In other embodiments, other sensors may equally apply, or sensors 202 may provide detection functions other than sensing gases. For example, as shown in FIG. 5, a produce display scale system 300 may be included. The produce display scale 300 may be a standalone system, for example, similar to the air flow sensor system 140 shown in FIG. 2, except that the gas sensors 202 are replaced with pressure sensors 302 or the like. In the embodiment shown in FIG. 5, the produce display scale system 300 coexists with the air flow system 130 and gas sensor system 140, for example, to improve an accuracy rate with respect to detecting produce conditions. For example, the pressure sensors 302A-D (generally, 302), for example, a scale or the like, may sense a presence of produce on the produce bed 104, e.g., a weight or related force. The pressure sensors 302 may send information to the sensor controller 210 in a similar manner as the gas sensors 202, for example, information that no weight or a reduced produce weight is detected at a region of the produce bed 104, whereby the controller 210 controls the fans 132, 133, 138 accordingly. For example, the controller 210 may remove power from the fans when a determination is made that the produce bed 104 is empty.

In other embodiments, the produce display scale system 300 may establish from sensor data that the produce bed 104 is empty, whereby the air flow system 130 may be powered down or changed. In other examples, data collected from the weight sensors 302 and/or gas sensors 202 may be used by the controller and/or a remote device that processes the data for analytics or the like to determine when to replenish the produce table with new or different items, establish a current amount of produce in the produce table, and so on. For example, the gas sensors 202 may detect sufficient gas to establish that a produce item is decomposing. The weight sensors 302 can corroborate by determining that the weight of the produce item has decreased during a predetermined period. The controller 210 may store historical weight data to conclude that the produce item is indeed decomposing. As described above, sensor data may be transmitted via the LED transmitter 206 over a non-visual spectrum light system or the like. In some embodiments, the produce display scale system 300 collects produce weight information and communicates with the air sensor system 140, which can increase or decrease fan speeds or otherwise control air flow.

Although gas and pressure sensors are described, the produce table 10 may include other sensor types to detect the presence of perishable items on the produce bed 104 and/or freshness-related qualities of the perishable items. For example, a camera, chemical sensor, piezoelectric sensor, micro-electromechanical sensor, nanomechanical sensor, optical sensor, and so on may equally apply, for acquiring data, e.g., chemical, electronic, and/or the like used to monitor the produce bed 104, for example, measure display bed and/or contents' total volume and/or one or more of the perishable items located therein, such as the color or visual appearance of the items, or the atmosphere of the produce bed 104.

The descriptions of the various embodiments of the present inventive concepts have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An air circulation and ventilation system for a retail store produce display, comprising:
an air flow system that outputs an air flow to the produce display;
a sensor system that determines a condition of the produce in the produce display;
a sensor controller that controls the air flow system to change the air flow in the produce display in response to the condition of the produce in the produce display; and
a self-contained power panel for powering the air flow system and the sensor system.

2. The system of claim 1, wherein the sensor system includes a plurality of gas sensors that sense an emission of a gas from the produce in the produce display, and determines an amount of freshness or ripeness of the produce based on the emitted gas.

3. The system of claim 2, wherein the sensor controller reverses the air flow in the produce display in response to the gas sensors determining that the emitted gas exceeds a threshold.

4. The system of claim 1, wherein the sensor controller outputs an instruction to the air flow system to reverse the air flow at an automated, regular time interval.

5. The system of claim 1, wherein the sensor system further comprises a plurality of weight sensors that determine a presence or change in weight of the produce, and wherein the sensor controller changes the air flow in the produce display in response to the sensor system determining that the produce display is devoid of the produce or that the produce has changed weight.

6. The system of claim 5, wherein the weight sensors include a scale that communicates with the sensor system to determine if vents in the air flow system need to be operating.

7. The system of claim 5, wherein the scale communicates with the sensor system to change fan speeds of the air flow system and modify air circulation.

8. The system of claim 1, further comprising a notification system comprising:
a sensor transmitter that outputs data in a non-visual light spectrum;
at least one optical sensor that detects the non-visual light spectrum; and
a controller that outputs notification data received in the non-visual light spectrum, the notification data including information for a user of the condition of the produce in the produce display.

9. A display table or kiosk for store produce items, comprising:
a base;
a produce bed on the base for holding retail produce items;
an air circulation and ventilation system that outputs a controlled air flow to the produce bed, monitors a condition of the produce in the produce display, and changes the air flow in the produce display in response to the condition of the produce in the produce display; and
a notification system that outputs information of the condition of the produce in the produce display.

10. The display table or kiosk of claim 9, further comprising a bottom section including shelves.

11. The display table or kiosk of claim 10, further comprising a perimeter and divider forming sectional divisions about the produce bed.

12. The display table or kiosk of claim 9, further comprising a self-contained power panel for powering the air circulation and ventilation system and the notification system.

13. The display table or kiosk of claim 9, wherein the power panel is a solar panel or incandescent power panel.

14. The display table or kiosk of claim 9, wherein the air circulation and ventilation system comprises:
an air flow system that outputs the air flow to the produce display;
a sensor system that determines the condition of the produce in the produce display; and
a sensor controller that controls the air flow system to change the air flow in the produce display in response to the condition of the produce in the produce display.

15. The display table or kiosk of claim 14, wherein the air flow system includes a plurality of fans powered by the power panel for providing air induction.

16. The display table or kiosk of claim 9, wherein the sensor system further comprises a plurality of weight sensors that determine a presence or change in weight of the produce, and wherein the sensor controller changes the air flow in the produce display in response to the sensor system determining that the produce display is devoid of the produce or that the produce has changed weight.

17. The display table or kiosk of claim 9, further comprising a notification system comprising:
a sensor transmitter that outputs data in a non-visual light spectrum;
at least one optical sensor that detects the non-visual light spectrum; and
a controller that outputs notification data received in the non-visual light spectrum, the notification data including information for a user of the condition of the produce in the produce display.

18. A sensor system that determines a condition of the produce in the produce display, comprising:
a plurality of gas sensors that sense an emission of a gas from the produce in the produce display, and determines an amount of freshness or ripeness of the produce based on the emitted gas;
a plurality of weight sensors that determine a presence or change in weight of the produce,
at least one optical sensor that detects wavelengths of light including notification data from a sensor transmitter, the notification data including information regarding the condition of the produce in response to the gas and weight sensors; and
a sensor controller that controls a source of air flow in the product display in response to a detected condition of the produce detected by gas and weight sensors.
